(19) United States
(12) Patent Application Publication
(10) Pub. No.: US 2014/0090025 A1
(43) Pub. Date: Mar. 27, 2014

(54) INFORMATION PROCESSING DEVICE AND METHOD

(71) Applicant: Yahoo Japan Corporation, Tokyo (JP)

(72) Inventor: Shinya AOKI, Tokyo (JP)

(73) Assignee: YAHOO JAPAN CORPORATION, Tokyo (JP)

(21) Appl. No.: 13/963,119

(22) Filed: Aug. 9, 2013

(30) Foreign Application Priority Data
Sep. 21, 2012 (JP) 2012-208779

(51) Int. Cl. H04L 29/06

(52) U.S. Cl. CPC H04L 63/10
USPC 726/4

(57) ABSTRACT

Access restriction is performed on access to a page on which information is posted from a terminal of a subject. It is determined whether positions of terminals used by the subject and a manager, who is associated with the subject in advance, accord with each other. A relaxation operation is received from the terminal of the manager, when it is determined that the positions accord with each other. The access restriction by a restriction unit is relaxed, when the relaxation operation is received. A characteristic word of the page accessed by the terminal of the subject for which the access restriction is relaxed is acquired. The acquired characteristic word is transmitted to the terminal of the manager to display the characteristic word. A recovery operation is received from the terminal of the manager. The access restriction performed by the restriction unit is recovered, when the recovery operation is received.

### CROSS-REFERENCE TO RELATED APPLICATIONS

The present application claims priority to and incorporates by reference the entire contents of Japanese Patent Application No. 2012-208779 filed in Japan on Sep. 21, 2012.

### BACKGROUND OF THE INVENTION

1. Field of the Invention

The present invention relates to security of an information service.

2. Description of the Related Art

Filtering (for example, see Japanese Patent No. 4926130) recently in widespread use is a technology for fulfilling sound development or security of children or the like by performing access restriction on web pages or the like on which harmful content is posted from terminals.

In the conventional techniques, however, for example, when a caution way is taught to children by temporarily showing an example of a harmful web page under the supervision of their parents, setting such as temporary cancellation of application or a change in a filtering level has been troublesome. In particular, when an operation of changing access restriction is set to be easily performed, a risk of unexpected relaxation of the access restriction may increase. On the other hand, when a setting change order is set to be strict, setting change by parents may also be troublesome.

### SUMMARY OF THE INVENTION

It is an object of the present invention to at least partially solve the problems in the conventional technology.

According to one aspect of an embodiment of the present invention, an information processing device includes: a restriction unit that performs access restriction on access to a page on which information is posted from a terminal of a subject; an accompanying determination unit that determines whether positions of terminals used by the subject and a manager, who is associated with the subject in advance, accord with each other; a relaxation reception unit that receives a relaxation operation for relaxing the access restriction temporarily from the terminal of the manager or the subject, when it is determined that the positions of the terminals used by the subject and the manager accord with each other; a relaxation unit that relaxes the access restriction performed by the restriction unit, when the relaxation operation is received; a characteristic word acquisition unit that acquires a characteristic word of the page accessed by the terminal of the subject for which the access restriction is relaxed; a characteristic word transmission unit that transmits the acquired characteristic word to the terminal of the manager to display the characteristic word; a recovery reception unit that receives a recovery operation of recovering the access restriction from the terminal of the manager; and a recovery unit that recovers the access restriction performed by the restriction unit, when the recovery operation is received.

According to another aspect of an embodiment of the present invention, An information processing method executed by a computer, the method includes: performing access restriction on access to a page on which information is posted from a terminal of a subject; determining whether positions of terminals used by the subject and a manager, who is associated with the subject in advance, accord with each other; receiving a relaxation operation for relaxing the access restriction temporarily from the terminal of the manager or the subject, when it is determined that the positions of the terminals used by the subject and the manager accord with each other; relaxing the access restriction by the restriction unit, when the relaxation operation is received; acquiring a characteristic word of the page accessed by the terminal of the subject for which the access restriction is relaxed; transmitting the acquired characteristic word to the terminal of the manager to display the characteristic word; receiving a recovery operation of recovering the access restriction from the terminal of the manager; and recovering the access restriction by the restriction unit, when the recovery operation is received.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram illustrating a configuration according to an embodiment of the invention;

FIG. 2 is a diagram illustrating an example of information (data) according to the embodiment of the invention;

FIG. 3 is a flowchart illustrating a processing order according to the embodiment of the invention;

FIG. 4 is a diagram illustrating a screen display example (setting change) according to the embodiment of the invention;

FIG. 5 is a diagram illustrating a screen display example (relaxation operation) according to the embodiment of the invention; and

FIG. 6 is a diagram illustrating a screen display example according to the embodiment of the invention.

### DETAILED DESCRIPTION OF THE PREFERRED EMBODIMENTS

Hereinafter, modes (referred to as “embodiments”) for carrying out the present invention will be exemplified with reference to the drawings. The assumption factors common to the details described above in the technical background, the problems, and the like will be appropriately not made.

### 1. Configuration

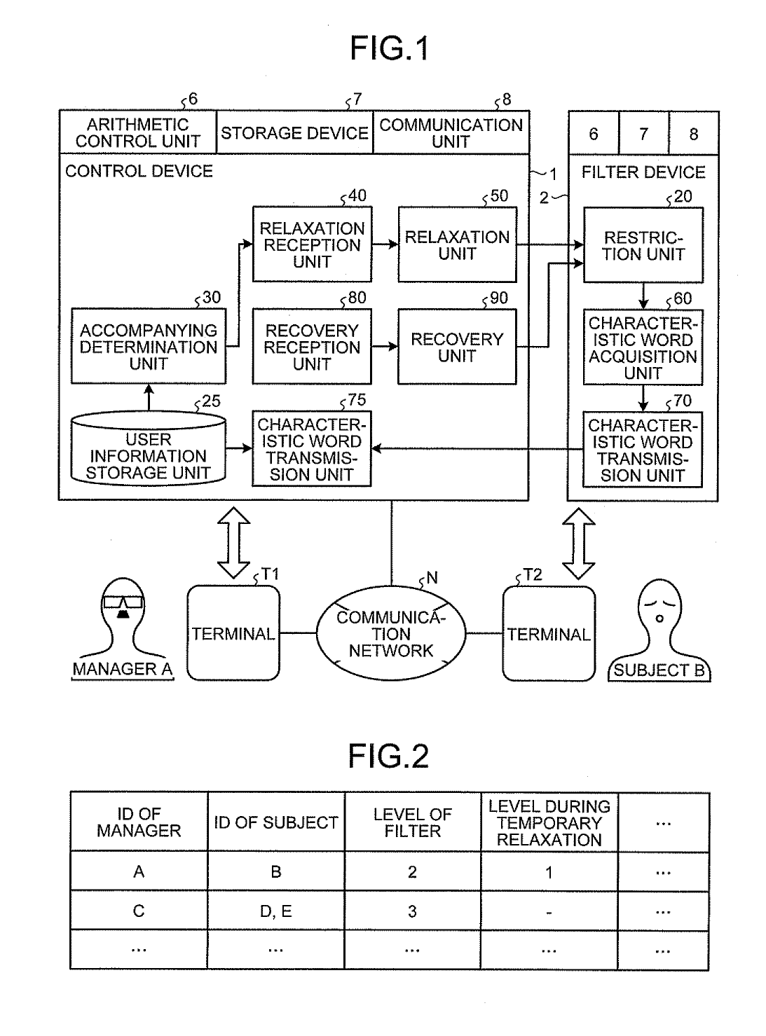

FIG. 1 is a diagram illustrating an overall configuration according to the embodiment. A filter device 2 is a device that provides access restriction such as filtering of access to the Internet. The access restriction is performed by a device that provides access restriction (hereinafter, referred to as “filter”) on access to a page on which information is posted from a terminal T2 of a subject B. The access restriction is performed according to a white list scheme, a black list scheme, or another scheme.

In this embodiment, a filter subject B which is a child is assumed to use the terminal T2 and a manager A who is a parent and associated with the subject B in advance is assumed to use a terminal T1. In practice, there are a plurality of subjects and terminals. In FIG. 1, however, the subject B and the terminal T2 are illustrated as representative examples. The same also applies to the manager A and the terminal T1. An example of the “manager” is assumed to be a parent, but the “subject” is not limited to a child. A corporate member or another organization member may be assumed to be the subject B. Further, an executive officer or a senior of another organization may be assumed to be the manager A.

The “page on which information is posted” which is an access restriction target is, for example, a web page or a pdf file, but may be a page with any format of which switch is controlled by an application program (also referred to as an “app”), a CGI, a script, or the like.

A control device 1 is an information processing device according to the present invention and is a device that controls execution or non-execution of filter application by the filter device 2 and levels of the filter application for each subject. Further, terminals T (T1 and T2) are mobile information terminals, such as smartphones or portable telephone terminals, including computers and are used by the manager A or the subject B to access a web page of the Internet or the control device 1.

The control device 1 and the filter device 2 (referred to as “devices 1 and 2”) include an arithmetic control unit 6 such as a CPU, a storage device 7 such as main memory or an auxiliary storage device (for example, flash memory or others), and a communication unit 8 (for example, a communication circuit or a wireless LAN adapter communicating with a mobile communication network) communicating with a communication network N (for example, the Internet or various wireless communication networks of cellular phones, PHSs, public wireless LANs, and the like), as a configuration of a computer.

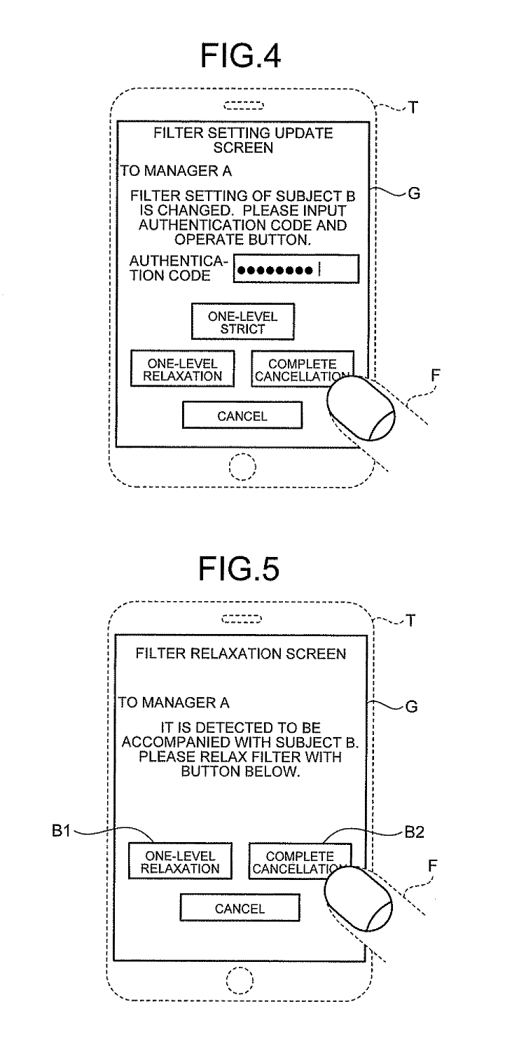

Although not illustrated, the terminals T further include a rechargeable battery control unit that controls charging and discharging of an internal battery, a calling control unit that performs sending or receiving of call or sound processing, and a positioning unit that positions a location of a terminal using GPS or the like, in addition to the above-described configuration of the computer. The terminals T further include a display screen (denoted by, for example, reference numeral G of FIG. 4) such as a liquid crystal of a touch panel function unit.

In the devices 1 and 2, constituent elements illustrated in FIG. 1 are realized by causing the arithmetic control unit 6 to execute a program (not illustrated). The program is, for example, basic software, an application program, various kinds of middleware, or a script. Of the realized constituent elements, an information storage mechanism may be not only various files or work areas on the storage device 7 but also remote storages or the like realized by network computer (cloud).

The storage unit may include not only a data storage region but also a function such as input and output or management of data. Units of the storage units are illustrated in the description merely by way of example, and the storage units can be divided or integrated as appropriate. Further, besides the storage units specifically described in the description, additional storage units may be employed to store processed data, processed results, or the like.

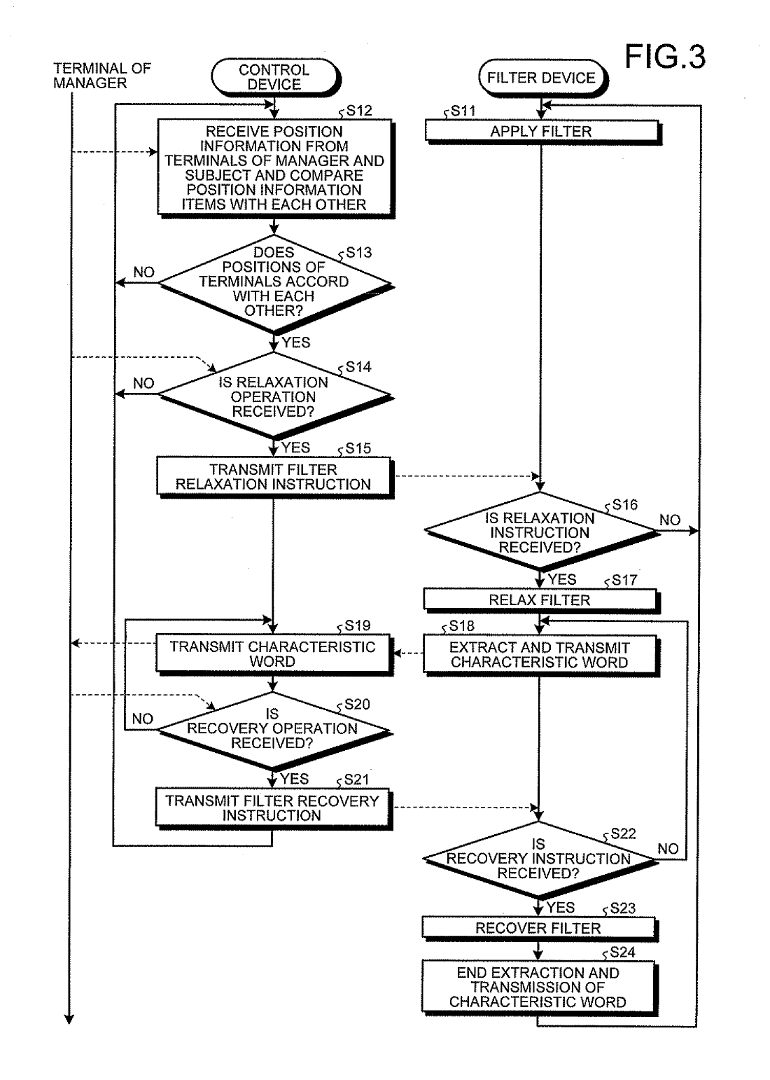

FIG. 2 illustrates an example of information stored in a user information storage unit 25. In this example, for each ID of a manager, the ID of a corresponding subject, a level of a filter to be applied, and a level of the filter during temporary relaxation at the time of the temporary relaxation of the level of the filter are associated with each other. The level of the filter exemplified in FIG. 2 is stricter, as a number is larger. For example, the level of the filter for the subject B is set to “2” in advance by the manager A, but is relaxed to a level “1” temporarily.

An arrow in the drawing (for example, FIG. 1) indicates a main direction of flow of data, control, or the like in an auxiliary manner and does not mean negation of another flow or limitation to a direction. For example, before and after data is acquired in a given direction, a data request or a response of acknowledgement (ACK) can be generated in an opposite direction thereto.

Respective units other than the storage unit are processing units that realize and perform a functional process of the information processing to be described below. However, the units are functional units for the description, and thus may not accord with actual hardware elements or software modules.

### 2. Processes

FIG. 3 is a flowchart illustrating a processing order according to this embodiment. In the filter device 2, a restriction unit 20 applies a filter set in advance by the manager A to Internet access from the terminal T2 of the subject B (step S11).

In this state, for example, a case will be considered in which the manager A, who is a parent, temporarily cancels the filter application or changes the level of the filter for the subject B, who is a child, to teach the subject B a caution or countermeasure way by temporarily showing an example of a harmful web page under the supervision of the manager A.

In this case, there are two options used for the manager A to control setting of the filter application. One of the options is an operation of permanently changing the access restriction on a screen for filter setting, as in the conventional technique, without using the relaxation operation of this embodiment, and this operation is referred to as “setting change.” The setting change is an operation of changing the access restriction, when it is determined that the positions of the terminals used by the subject B and the manager A do not accord with each other.

FIG. 4 illustrates a screen example configured for the setting change. Even when the manager A is not actually beside the subject B, the manager A can operate the setting change to change the access restriction from this screen anytime and anywhere, irrespective of the flowchart of FIG. 3. However, in the setting change, it is necessary to input a predetermined authentication code set in advance.

The other option used for the manager A to change the access restriction is an option for which the relaxation operation of this embodiment is used according to the flowchart of FIG. 3. The relaxation operation is performed when the manager A is with the subject B. However, the relaxation operation is an operation different from the setting change (FIG. 4) and is completed through a simpler operation without inputting an authentication code, as exemplified in FIG. 5. The relaxation operation may be performed from the terminal of the subject B.

To use the relaxation operation, the terminal T1 of the manager A and the terminal T2 of the subject B are gathered, and an access to a predetermined URL or a predetermined application starts to be performed to control the filter in the mutually accompanied state. The relaxation operation may be an operation associated with a temporary condition such as 1 hour restriction.

### 2-1. Accompanying Determination

On the other hand, in the control device 1, an accompanying determination unit 30 determines that the positions of terminals used by a subject and a manager, who is associated with the subject in advance, accord with each other, that is, the terminals are accompanied at the same place. Hereinafter, the fact that the positions of terminals used by a subject and a manager accord with each other is referred to as “accompanying.”

Specifically, the accompanying determination unit 30 periodically acquires position information regarding the terminal T2 from the terminal T2 of the subject B and acquires position information regarding the terminal T1 from the terminal T1 of the manager A (step S12), and then determines that the positions of the terminals used by the subject B and the manager A accord with each other when a distance between the position coordinates indicated by the acquired position information is within a predetermined value (“YES” in step S13).

Further, the accompanying determination unit 30 may be configured to determine that the positions of the terminals used by the subject B and the manager A accord with each other, when the accompanying determination unit 30 determines that predetermined information is directly transmitted and received between the terminal T2 of the subject B and the terminal T1 of the manager A. The “direct transmission and reception of predetermined information” refers to, for example, transmission of data from one of the terminals to the other terminal by infrared light or the like or access of one of the terminals to a URL displayed on the other terminal, and means that both of the terminals are located within a predetermined distance.

As an example of the transmission by infrared light, data transmitted from the control device 1 to one of the terminals is transmitted from the one terminal to the other terminal by infrared communication or short-range wireless communication and the terminal receiving the data transmits the data to the control device 1. Then, when the transmitted data accords with the received data, the control device 1 determines that the positions of both of the terminals accord with each other.

As an example of the transmission by a URL, a two-dimensional barcode shown on the URL of a predetermined web page provided by the control device 1 is transmitted from the control device 1 to one of the terminals, is displayed on a screen, and is read by a camera function of the other terminal, so that access to the URL is performed. When the control device 1 receives, for example, an HTTP page request to the URL, it is determined that the positions of both of the terminals accord with each other.

### 2-2. Relaxation of Filter

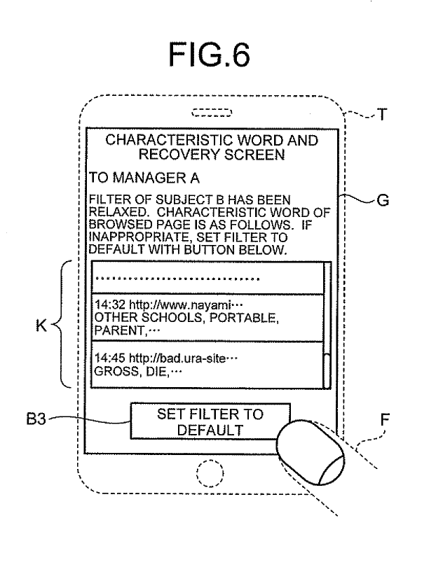

When it is determined that the positions of the terminals used by the subject and the manager accord with each other (“YES” in step S13), a relaxation reception unit 40 receives the relaxation operation for relaxing the access restriction temporarily such that the manager A causes a screen as illustrated in FIG. 5 to be displayed and makes an operation on the screen (step S14). The screen of FIG. 5 or a screen of FIG. 6 (which will be described below) are displayed by web data such as HTML or an app. When it is determined that the terminals are accompanied, the screen of FIG. 5 may be automatically displayed.

When a button B1 is tapped with a finger F on the screen of FIG. 5, the level of the filter is relaxed temporarily by one level from the current level. When a button B2 of complete cancellation is tapped, the application of the filter is temporarily stopped. When the level of the filter is relaxed, for example, a category or a specific page which has not been browsed until then can be browsed.

When the relaxation operation is received (“YES” in step S14), a relaxation unit 50 relaxes the filter applied by the restriction unit 20. Specifically, the relaxation unit 50 transmits a filter relaxation instruction to the filter device 2 (step S15). The filter relaxation instruction is data that is used to notify of lowering of the level of the filter, cancelation of the filter of a page of specific characteristics or a category, temporary interruption of the filter, or the like. When the restriction unit 20 of the filter device 2 receives the relaxation instruction (“YES” in step S16), the relaxation unit 50 relaxes the filter according to contents of the relaxation instruction (step S17).

### 2-3. Transmission of Characteristic Word

When the filter is relaxed, a characteristic word starts to be extracted and transmitted from a page accessed and browsed by the terminal T2 of the subject B for which the filter is relaxed (step S18). Specifically, a characteristic word acquisition unit 60 acquires the characteristic word of the page accessed by the terminal T2 of the subject B for which the access restriction is relaxed, and then a characteristic word transmission unit 70 transmits the acquired characteristic word to the terminal T1 of the manager A to display the characteristic word.

A timing at which the characteristic word is acquired and transmitted is, for example, a time at which a page of a new URL is opened or a time at which the contents of a previously opened page are updated due to posting or the like. Further, an existing method such as TF-TDF can be used as a method of acquiring the characteristic word. The acquired characteristic word may be transmitted directly from the filter device 2 to the terminal T1 of the manager. In this embodiment, however, a characteristic word transmission unit 75 of the control device 1 is assumed to transmit the characteristic word (step S19).

FIG. 6 is a diagram illustrating an example of a screen on which the characteristic word transmitted in the above-described way is displayed and a filter recovery operation is received, in the terminal. T1. On this screen, one or two or more characteristic words are updated and displayed sequentially in a form added to a keyword display section K so as to be scrolled on each page browsed by the terminal T2 of the subject B. The manager A can view the displayed characteristic word and comprehend characteristics of the page browsed by the subject B.

### 2-4. Recovery of Filter

When the page browsed by the subject B is inappropriate for the purpose to relax the filter temporarily, the access restriction can be recovered to the state prior to the relaxation operation by tapping a button B3 to “set the filter to default” with the finger F or the like.

That is, when a recovery reception unit 80 receives the recovery operation of recovering the access restriction from the terminal T1 of the manager A (“YES” in step S20), a recovery unit 90 recovers the access restriction performed by the restriction unit 20.

Specifically, the recovery unit 90 transmits a filter recovery instruction to the filter device 2 (step S21). When the restriction unit 20 of the filter device 2 receives this recovery instruction (“YES” in step S22), the application of the filter to the original level is recovered (step S23) and the characteristic word acquisition unit 60 and the characteristic word transmission unit 70 end the extraction and the transmission of the characteristic word (step S24).

### 3. Advantages

In this embodiment, as described above, the access restriction on the subject B is relaxed through the simple relaxation operation (for example, FIG. 5) under the condition in which the subject B is accompanied by the manager A. Thus, it is possible to relax the access restriction temporarily through an easy operation under the supervision of the manager A, while the risk of unexpected relaxation of the access restriction is suppressed.

During the relaxation, a characteristic word of a page browsed by the subject B is transmitted to the terminal T1 of the manager A and the operation of recovering the access restriction is received (for example, FIG. 6). Accordingly, a chance to recovery the access restriction can be ensured due to the supervision of the manager A on the contents browsed during the relaxation and it is possible to avoid a risk of forgetting to return the access restriction to the original access restriction.

In particular, in this embodiment, it is determined that the subject B is accompanied by the manager A when the distance between the position coordinates indicated by the position information acquired from both of the terminals of the subject B and the manager A is within the predetermined value (“YES” in step S13). Thus, it is possible not to perform a process or an operation of directly transmitting and receiving information between the terminals T1 and T2 of the subject and the manager to determine whether the subject is accompanied by the manager.

In this embodiment, it is determined that the subject B is accompanied by the manager A based on the direct transmission and reception of the predetermined information between the terminal T2 of the subject B and the terminal T1 of the manager A. Thus, when the subject B and the manager A are separately located in adjacent rooms or the like for which it is considered that the position information is the same, it may not erroneously be determined that the subject B is accompanied by the manager A and accompanying determination accuracy can be improved.

In this embodiment, by setting the relaxation operation (for example, FIG. 5), which can be performed when it is determined that the subject B is accompanied by the manager A, as an operation different from the setting change (for example, FIG. 4) at a time other than the time of the accompanying, the access restriction can be relaxed through the operation (FIG. 5) easier than the setting change (FIG. 4) at the time of the accompanying, and thus excellent usability can be realized.

### 4. Other Embodiments

The above-described embodiment is merely an example and the present invention includes embodiments to be exemplified below and other embodiments. For example, in the present application, the configuration diagrams, the drawings of the data, the flowchart, the drawings of the screens, and the like are merely examples. Presence or absence of each constituent element, the disposition of each constituent element, an order of the processing execution or the like, the specific contents, and the like can be appropriately changed. For example, the control device 1 and the filter device 2 may be integrally formed. Further, the number of managers and subjects may not have a one-to-one relation, but may have a one-to-many, many-to-one, or many-to-many relation.

Each aspect described in the present application may be comprehended as another non-stated category (a method, a program, a system including terminals, or the like). In the category of the method or the program, the “unit” described in the category of the device is appropriately replaced with a “process” or a “step.” An order of processes or steps is not limited to the order directly stated in the present application, but the order may be changed or the processes may be changed. For example, some of the processes may be summarized or the processes may be frequently performed in parts.

Computers realizing and executing the individual units and the processes or steps may be common or may be different for each unit, each process or step, or each timing. For example, the control device 1 or the filter device 2 may be configured as a plurality of server computers. Further, all or arbitrary some of the above-described “units” may be replaced with “portions” (sections, modules, or the like).

An aspect for realizing individual units of the control device 1 or the filter device 2 is freely configured, and thus the configuration of the present invention may be flexibly changed. For example, functions provided by an external server may be called and realized by an API (Application Program Interface) or network computing (so-called cloud or the like). Further, each constituent element such as a unit relevant to the present invention is not limited to an arithmetic control unit of a computer, but may be realized by another information processing mechanism such as a physical electronic circuit.

According to an embodiment of the invention, it is possible to relax access restriction temporarily through an easy operation under the supervision of a manager.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a restriction unit that performs access restriction on access to a page on which information is posted from a terminal of a subject;
an accompanying determination unit that determines whether positions of terminals used by the subject and a manager, who is associated with the subject in advance, accord with each other;
a relaxation reception unit that receives a relaxation operation for relaxing the access restriction temporarily from the terminal of the manager or the subject, when it is determined that the positions of the terminals used by the subject and the manager accord with each other;
a relaxation unit that relaxes the access restriction performed by the restriction unit, when the relaxation operation is received;
a characteristic word acquisition unit that acquires a characteristic word of the page accessed by the terminal of the subject for which the access restriction is relaxed;
a characteristic word transmission unit that transmits the acquired characteristic word to the terminal of the manager to display the characteristic word;
a recovery reception unit that receives a recovery operation of recovering the access restriction from the terminal of the manager; and
a recovery unit that recovers the access restriction performed by the restriction unit, when the recovery operation is received.

2. The information processing device according to claim 1, wherein the accompanying determination unit acquires terminal position information from the terminal of the subject, acquires terminal position information from the terminal of the manager, and determines that the positions of the terminals used by the subject and the manager accord with each other when a distance between position coordinates indicated by the acquired position information is within a predetermined value.

3. The information processing device according to claim 1, wherein the accompanying determination unit determines that the positions of the terminals used by the subject and the manager accord with each other, when it is determined that information determined in advance is directly transmitted and received between the terminals of the subject and the manager.

4. The information processing device according to claim 1, wherein the relaxation operation is an operation different from an operation of changing the access restriction, when it is determined that the positions of the terminals used by the subject and the manager do not accord with each other.

5. An information processing method executed by a computer, the method comprising:
performing access restriction on access to a page on which information is posted from a terminal of a subject;
determining whether positions of terminals used by the subject and a manager, who is associated with the subject in advance, accord with each other;
receiving a relaxation operation for relaxing the access restriction temporarily from the terminal of the manager or the subject, when it is determined that the positions of the terminals used by the subject and the manager accord with each other;
relaxing the access restriction by the restriction unit, when the relaxation operation is received;
acquiring a characteristic word of the page accessed by the terminal of the subject for which the access restriction is relaxed;
transmitting the acquired characteristic word to the terminal of the manager to display the characteristic word;
receiving a recovery operation of recovering the access restriction from the terminal of the manager; and
recovering the access restriction by the restriction unit, when the recovery operation is received.
